(19) United States
(12) Patent Application Publication
(10) Pub. No.: US 2026/0129613 A1
(43) Pub. Date: May 7, 2026

(54) METHOD AND APPARATUS FOR PERFORMING LOWER-LAYER TRIGGERED MOBILITY OF USER EQUIPMENT USING CONDITIONS IN A WIRELESS COMMUNICATION SYSTEM

(71) Applicant: Samsung Electronics Co., Ltd., Suwon-si (KR)

(72) Inventors: June HWANG, Suwon-si (KR); Seungri JIN, Suwon-si (KR)

(21) Appl. No.: 19/382,942

(22) Filed: Nov. 7, 2025

(30) Foreign Application Priority Data
Nov. 7, 2024 (KR) 10-2024-0157305

(51) Int. Cl. H04W 64/00; H04L 5/00; H04W 48/20

(52) U.S. Cl. CPC H04W 64/006; H04L 5/0094; H04W 48/20

(57) ABSTRACT

The disclosure relates to a 5^{th} generation (5G) or 6^{th} generation (6G) communication system for supporting a higher data transmission rate. A method and an apparatus are provided. According to an embodiment, the method performed by a user equipment (UE) in a wireless communication system comprises receiving, from a base station (BS), configuration information for a layer ½ triggered mobility (LTM), and condition information for a conditional LTM (CLTM), identifying a candidate cell for the CLTM based on the condition information, identifying a candidate beam of the identified candidate cell based on the condition information, performing a condition evaluation for the candidate beam of the candidate cell based on a layer 1 (L1) measurement for the candidate beam, and performing a CLTM procedure for the candidate cell based on an corresponding LTM candidate configuration included in the configuration information, in case that a condition in the condition information is fulfilled for the candidate beam.

### CROSS-REFERENCE TO RELATED APPLICATION(S)

This application is based on and claims priority under 35 U.S.C. § 119(a) of a Korean patent application number 10-2024-0157305, filed on Nov. 7, 2024, in the Korean Intellectual Property Office, the disclosure of which is incorporated by reference herein in its entirety.

### BACKGROUND

### 1. Field

The disclosure relates to a wireless communication system. More particularly, the disclosure relates to a method and an apparatus for performing lower-layer mobility of a terminal by using a condition in a wireless communication system.

### 2. Description of Related Art

5^{th} generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement 6^{th} generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical (PHY) layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and an apparatus for using a condition for performing lower-layer mobility of a terminal in a wireless communication system.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system comprises receiving, from a base station (BS), configuration information for a layer ½ triggered mobility (LTM), and condition information for a conditional LTM (CLTM), identifying a candidate cell for the CLTM based on the condition information, identifying a candidate beam of the identified candidate cell based on the condition information, performing a condition evaluation for the candidate beam of the candidate cell based on a layer 1 (L1) measurement for the candidate beam; and performing a CLTM procedure for the candidate cell based on an corresponding LTM candidate configuration included in the configuration information, in case that a condition in the condition information is fulfilled for the candidate beam.

In accordance with an aspect of the disclosure, a method performed by a base station (BS) in a wireless communication system comprises, transmitting, to a user equipment (UE), configuration information for a layer ½ triggered mobility (LTM), and condition information for a conditional LTM (CLTM), and performing a CLTM procedure for a candidate cell based on an corresponding LTM candidate configuration included in the configuration information, in case that a condition in the condition information is fulfilled for a candidate beam of the candidate cell, wherein an identification of the candidate cell and the candidate beam is based on the condition information, wherein an evaluation of the condition is based on a layer 1 (L1) measurement for the candidate beam.

In accordance with an aspect of the disclosure, a user equipment (UE) comprises at least one transceiver, at least one processor communicatively coupled to the at least one transceiver, and at least one memory, communicatively coupled to the at least one processor, storing instructions executable by the at least one processor individually or in any combination to cause the UE to receive, from a base station (BS), configuration information for a layer ½ triggered mobility (LTM), and condition information for a conditional LTM (CLTM), identify a candidate cell for the CLTM based on the condition information, identify a candidate beam of the identified candidate cell based on the condition information, perform a condition evaluation for the candidate beam of the candidate cell based on a layer 1 (L1) measurement for the candidate beam, and perform a CLTM procedure for the candidate cell based on an corresponding LTM candidate configuration included in the configuration information, in case that a condition in the condition information is fulfilled for the candidate beam.

In accordance with an aspect of the disclosure, a base station (BS) comprising, at least one transceiver, at least one processor communicatively coupled to the at least one transceiver; and at least one memory, communicatively coupled to the at least one processor, storing instructions executable by the at least one processor individually or in any combination to cause the BS to transmit, to a user equipment (UE), configuration information for a layer ½ triggered mobility (LTM), and condition information for a conditional LTM (CLTM), and perform a CLTM procedure for a candidate cell based on an corresponding LTM candidate configuration included in the configuration information, in case that a condition in the condition information is fulfilled for a candidate beam of the candidate cell, wherein an identification of the candidate cell and the candidate beam is based on the condition information, wherein an evaluation of the condition is based on a layer 1 (L1) measurement for the candidate beam.

In accordance with another aspect of the disclosure, an apparatus and a method capable of effectively providing services in a mobile communication system are provided.

In accordance with another aspect of the disclosure, a terminal is provided. The terminal performs via a specific beam-based event, conditional mobility for movement from a current cell and subsequent sequential movement without a separate signal from the network.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a wireless communication system according to an embodiment of the disclosure;

FIG. 2 illustrates a radio protocol structure in a wireless communication system according to an embodiment of the disclosure;

FIG. 3 illustrates a structure of a wireless communication system according to an embodiment of the disclosure;

FIG. 4 illustrates a radio protocol structure of a wireless communication system according to an embodiment of the disclosure;

FIG. 5 illustrates a structure of a UE according to an embodiment of the disclosure;

FIG. 6 illustrates a structure of a base station according to an embodiment of the disclosure;

FIG. 7 illustrates a structure of configuration information related to channel state information (CSI) measurement and reporting for local traffic manager triggered mobility (LTM) according to an embodiment of the disclosure;

FIG. 8 illustrates configuration information associated with conditional lower-layer triggered mobility (CLTM) in Opt 1 and an operation of a UE according to an embodiment of the disclosure;

FIG. 9 illustrates configuration information associated with CLTM in Opt 2 and an operation of a UE according to an embodiment of the disclosure;

FIG. 10 illustrates configuration information associated with CLTM in Opt 3 and an operation of a UE according to an embodiment of the disclosure;

FIG. 11 illustrates configuration information associated with CLTM in Opt 4 and an operation of a UE according to an embodiment of the disclosure;

FIG. 12 illustrates a configuration of condition-associated information included in an RRCReconfiguration message transferred to a UE in cases of Opts 1 and 2 according to an embodiment of the disclosure; and

FIG. 13 illustrates a configuration of condition-associated information included in an RRCReconfiguration message transferred to a UE in cases of Opts 3 and 4 according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, long term evolution (LTE) or long term evolution advanced (LTE-A) systems may be described by way of example, but the embodiments of the disclosure may also be applied to other communication systems having similar technical backgrounds or channel types. Examples of such communication systems may include the 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure. Herein, it will be understood that each block of the flowchart illustrations, and combinations of blocks in the flowchart illustrations, can be implemented by computer program instructions.

These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved. As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” in embodiments may include one or more processors.

In the following description of the disclosure, terms and names defined in 5G system (5GS) and NR standards, which are the standards specified by the 3rd generation partnership project (3GPP) group among the existing communication standards, will be used for the sake of descriptive convenience. However, the disclosure is not limited by these terms and names, and may be applied in the same way to systems that conform other standards. For example, the disclosure may be applied to the 3GPP 5GS/NR (5th generation mobile communication standards).

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

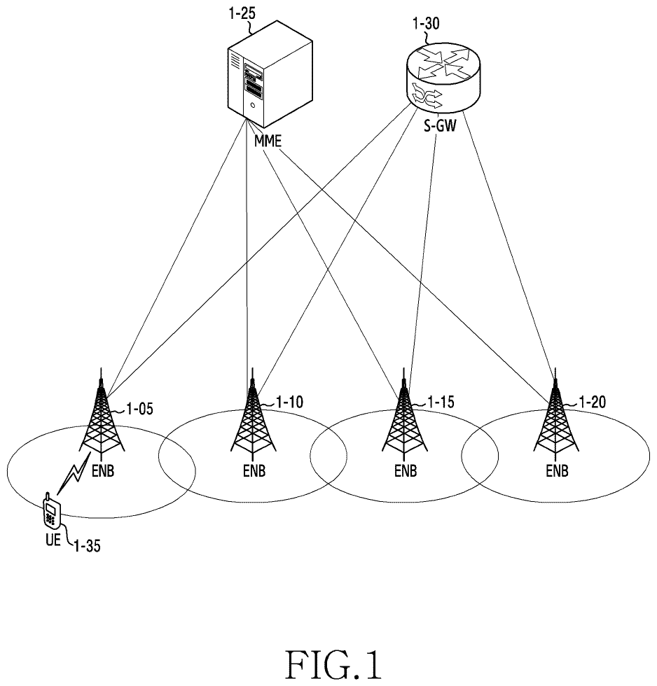

FIG. 1 illustrates a structure of a wireless communication system according to an embodiment of the disclosure.

Referring to FIG. 1, a radio access network of an LTE system may include next-generation base stations (evolved Node Bs, hereinafter ENBs, Node Bs, or base stations) 1-05, 1-10, 1-15, and 1-20, a mobility management entity (MME) 1-25, and a serving gateway (S-GW) 1-30. A user equipment (hereinafter UE or terminal) 1-35 may access an external network through the ENBs 1-05 to 1-20 and the S-GW 1-30.

In FIG. 1, the ENBs 1-05 to 1-20 may correspond to conventional Node Bs of a universal mobile telecommunication system (UMTS). The ENBs may be connected to the UE 1-35 through a radio channel, and perform more complicated roles than the conventional node Bs. In the LTE system, since all user traffic including real-time services, such as voice over internet protocol (IP) (VoIP) via the Internet protocol, may be serviced through a shared channel. Thus, a device that collects state information, such as buffer states, available transmit power states, and channel states of UEs, and performs scheduling accordingly is required, and the ENBs 1-05 to 1-20 may serve as the device. One ENB may control multiple cells. For example, in order to implement a transfer rate of 100 Mbps, the LTE system may use an orthogonal frequency division multiplexing (OFDM) scheme as radio access technology, for example, in a bandwidth of 20 MHz, but the radio access technology used in the LTE system for implementation of the transfer rate is not limited thereto. Furthermore, the ENBs 1-05 to 1-20 of the LTE system may employ an adaptive modulation & coding (AMC) scheme for determining a modulation scheme and a channel coding rate according to a channel state of a UE. The S-GW 1-30 is a device that provides a data bearer, and may generate or remove a data bearer under the control of the MME 1-25. The MME is a device responsible for various control functions as well as a mobility management function for a UE, and may be connected to multiple base stations.

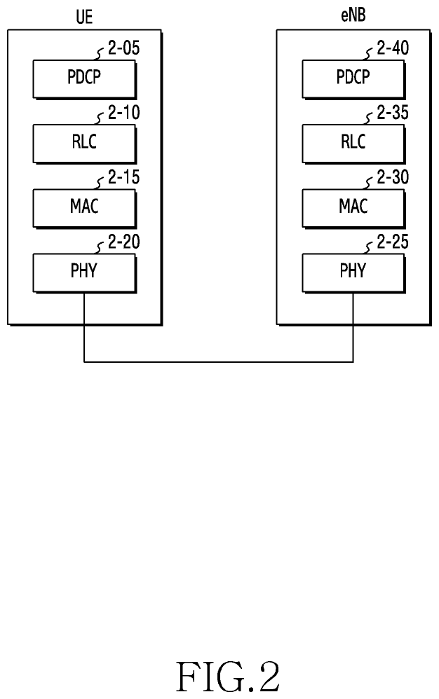

FIG. 2 illustrates a radio protocol structure in a wireless communication system according to an embodiment of the disclosure.

Referring to FIG. 2, a radio protocol of an LTE system may include a packet data convergence protocol (PDCP) 2-05 or 2-40, a radio link control (RLC) 2-10 or 2-35, a medium access control (MAC) 2-15 or 2-30, and a physical (PHY) layer 2-20 or 2-25 on each of UE and ENB sides, but the radio protocol structure of the LTE system is not limited to that illustrated in FIG. 2. For example, the radio protocol structure of the LTE system may include a larger or smaller number of layers than those of the structure illustrated in FIG. 2.

According to an embodiment of the disclosure, the PDCP 2-05 or 2-40 may serve to perform operations, such as IP header compression/reconstruction. The main functions of the PDCP 2-05 or 2-40 may be summarized as follows, but the functions of the PDCP 2-05 or 2-40 are not limited to the examples given below.
Header compression and decompression: robust header compression (ROHC) only
Transfer of user data
In-sequence delivery of upper layer protocol data units (PDUs) at PDCP re-establishment procedure for RLC acknowledged mode (AM)
For split bearers in dual connectivity (DC) (only support for RLC AM): PDCP PDU routing for transmission and PDCP PDU reordering for reception
Duplicate detection of lower layer service data units (SDUs) at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink

According to an embodiment of the disclosure, the radio link control (RLC) 2-10 or 2-35 may reconfigure a PDCP protocol data unit (PDU) into appropriate sizes to perform an automatic repeat request (ARQ) operation. The main functions of the RLC 2-10 or 2-35 may be summarized as follows, but the functions of the RLC 2-10 or 2-35 are not limited to the examples given below.
Transfer of upper layer PDUs
Error Correction through ARQ (only for AM data transfer)
Concatenation, segmentation and reassembly of RLC SDUs (only for unacknowledged mode (UM) and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

According to an embodiment of the disclosure, the MAC 2-15 or 2-30 may be connected to several RLC layer devices configured in a single UE, and multiplex RLC PDUs to an MAC PDU and demultiplex RLC PDUs from an MAC PDU. The main functions of the MAC 2-15 or 2-30 may be summarized as follows, but the functions of the MAC 2-15 or 2-30 are not limited to the examples given below.
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through hybrid automatic repeat request (HARQ)
Priority handling between logical channels of one UE
Priority handling between UEs by means of dynamic scheduling
Multimedia broadcast/multicast service (MBMS) service identification
Transport format selection
Padding

According to an embodiment of the disclosure, the PHY layer 2-20 or 2-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

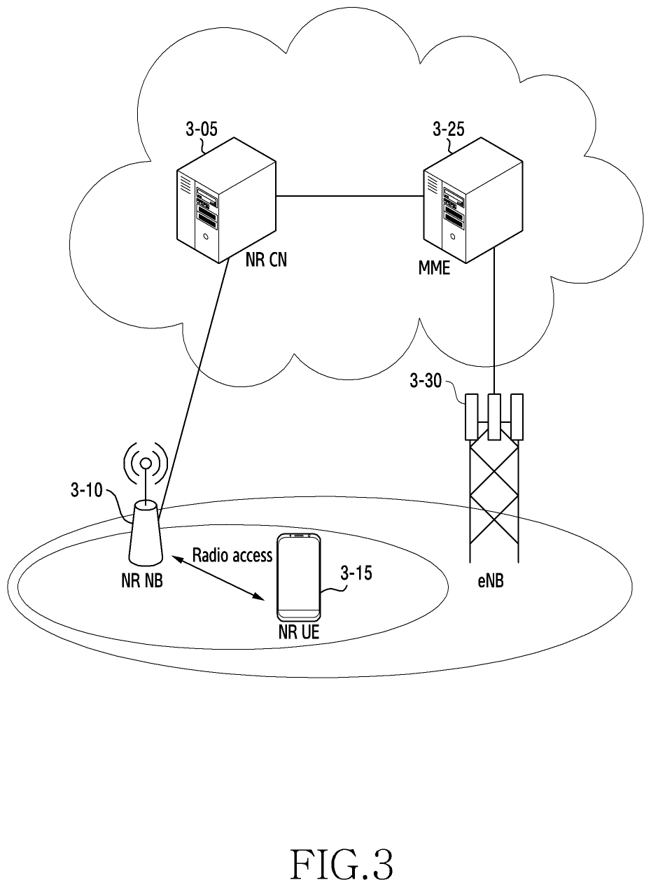

FIG. 3 illustrates a structure of a wireless communication system according to an embodiment of the disclosure.

Referring to FIG. 3, the wireless communication system according to an embodiment of the disclosure may include a next-generation mobile communication system (NR or 5G). A radio access network of the next-generation mobile communication system (hereinafter NR, or 5G) may include a new radio Node B (hereinafter NR gNB or NR base station) 3-10, and a new radio core network (NR CN) 3-05. A new radio user equipment (NR UE or terminal) 3-15 may access an external network via the NR gNB 3-10 and the NR CN 3-05.

In FIG. 3, the NR gNB 3-10 may correspond to an evolved Node B (eNB) of the conventional LTE system. The NR gNB may be connected to the NR UE 3-15 through a radio channel and provide outstanding services as compared to a conventional node B. In the next-generation mobile communication system, since all user traffic may be serviced through a shared channel. Thus, a device that collects state information, such as buffer states, available transmit power states, and channel states of UEs, and performs scheduling accordingly is required, and the NR gNB 3-10 may serve as the device. One NR gNB may control multiple cells.

According to an embodiment of the disclosure, in order to implement ultrahigh-speed data transfer beyond the typical LTE, the next-generation mobile communication system may provide a wider bandwidth than the existing maximum bandwidth. in addition, the next-generation mobile communication system may employ an orthogonal frequency division multiplexing (OFDM) as a radio access technology, and may additionally integrate a beamforming technology therewith.

Furthermore, according to an embodiment of the disclosure, the next-generation mobile communication system may employ an adaptive modulation & coding (hereinafter referred to as AMC) scheme for determining a modulation scheme and a channel coding rate according to the channel state of a UE. The NR CN 3-05 may perform functions such as mobility support, bearer configuration, and QoS configuration. The NR CN is a device responsible for various control functions as well as a mobility management function for a UE, and may be connected to multiple base stations.

In addition, according to an embodiment of the disclosure, the next-generation mobile communication system may interwork with the LTE system, and the NR CN may be connected to an MME 3-25 via a network interface. The MME may be connected to an eNB 3-30 that is an LTE base station.

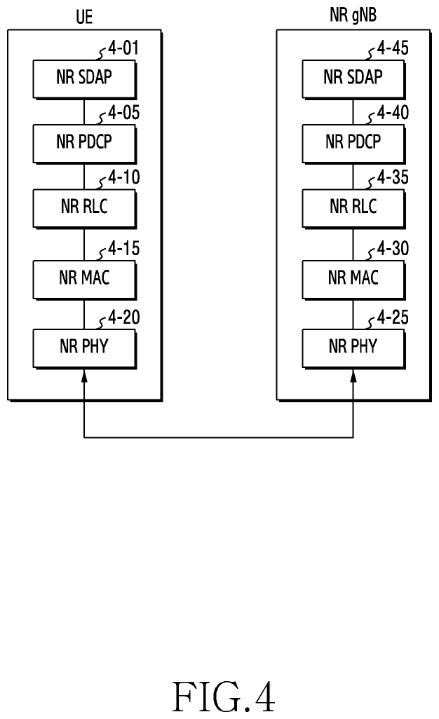

FIG. 4 illustrates a radio protocol structure of a next-generation mobile communication system according to an embodiment of the disclosure.

Referring to FIG. 4, a radio protocol of a next-generation mobile communication system may include an NR service data adaptation protocol (SDAP) layer 4-01 or 4-45, an NR PDCP layer 4-05 or 4-40, an NR RLC layer 4-10 or 4-35, an NR MAC layer 4-15 or 4-30, and an NR PHY layer 4-20 or 4-25 on each of UE and NR base station sides. Of course, the radio protocol of the next-generation mobile communication system may include a larger or smaller number of layers than those of the structure illustrated in FIG. 4.

As used hereinafter, the term “layer device” refers to an NR layer and may be interchangeably used with “layer”.

According to an embodiment of the disclosure, the main functions of the NR SDAP layer device 4-01 or 4-45 may include some of the following functions, but the functions of the NR SDAP layer device 4-01 or 4-45 are not limited to the examples given below.
Transfer of user plane data
Mapping between a QoS flow and a DRB for both DL and UL
Marking QoS flow ID in both DL and UL packets
Reflective QoS flow to DRB mapping for UL SDAP PDUs

According to an embodiment, with regard to the SDAP layer device 4-01 or 4-45, the UE may be configured, through an RRC message, whether to use the header of the SDAP layer device with regard to each PDCP layer device or with regard to each bearer or with regard to each logical channel, or whether to use functions of the SDAP layer device 4-01 or 4-45. If an SDAP header is configured, the non-access stratum (NAS) quality of service (QoS) reflection configuration 1-bit indicator (NAS reflective QoS) of the SDAP header and the access stratum (AS) QoS reflection configuration 1-bit indicator (AS reflective QoS) may indicate, to the UE, that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

According to an embodiment of the disclosure, the main functions of the NR PDCP layer device 4-05 or 4-40 may include some of the following functions, but the functions of the NR PDCP layer device 4-05 or 4-40 are not limited to the examples given below.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

Among the above-described functions, the reordering of the NR PDCP layer device 4-05 or 4-40 may refer to a function of reordering PDCP PDU received from a lower layer in an order based on PDCP sequence numbers (SNs). The reordering of the NR PDCP layer device 4-05 or 4-40 may include at least one of a function of transferring data to an upper layer according to a rearranged order, a function of directly transferring data without considering order, a function of rearranging order to record lost PDCP PDUs, a function of reporting the state of lost PDCP PDUs to a transmission side, or a function of requesting retransmission of lost PDCP PDUs.

According to an embodiment of the disclosure, the main functions of the NR RLC layer device 4-10 or 4-35 may include some of the following functions, but the functions of the NR RLC layer device 4-10 or 4-35 are not limited to the examples given below.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

Among the above-described functions, the in-sequence delivery of the NR RLC layer device 4-10 or 4-35 may refer to a function of delivering RLC SDUs, received from the lower layer, to the upper layer in sequence. The in-sequence delivery of the NR RLC layer device 4-10 or 4-35 may include a function of, if one original RLC SDU is segmented into multiple RLC SDUs and the segmented RLC SDUs are received, reassembling the multiple received segmented RLC SDUs and delivering the reassembled RLC SDUs to the upper layer.

According to an embodiment of the disclosure, the in-sequence delivery of the NR RLC layer device 4-10 or 4-35 may include at least one of a function of reordering the received RLC PDUs with reference to the RLC sequence number (SN) or PDCP sequence number (SN), a function of recording RLC PDUs lost as a result of reordering, a function of reporting the state of the lost RLC PDUs to the transmitting side, or a function of requesting retransmission of the lost RLC PDUs.

According to an embodiment of the disclosure, the in-sequence delivery of the NR RLC layer device 4-10 or 4-35 may include a function of, if there is a lost RLC SDU, sequentially delivering only RLC SDUs before the lost RLC SDU to the upper layer.

According to an embodiment of the disclosure, the in-sequence delivery of the NR RLC layer device 4-10 or 4-35 may also include a function of, although there is a lost RLC SDU, if a predetermined timer has expired, sequentially transferring all the RLC SDUs received up to the current, to an upper layer.

According to an embodiment of the disclosure, the in-sequence delivery of the NR RLC layer device 4-10 or 4-35 may include a function of, although there is a lost RLC SDU, if a predetermined timer has expired, sequentially delivering, to the upper layer, all the RLC SDUs received up to the current time.

According to an embodiment of the disclosure, the NR RLC layer device 4-10 or 4-35 may process RLC PDUs in a reception sequence, regardless of a sequence based on sequence numbers (out-of-sequence delivery). and then deliver the processed RLC PDUs to the NR PDCP layer device 4-05 or 4-40.

According to an embodiment of the disclosure, upon receiving segments, the NR RLC layer device 4-10 or 4-35 may receive segments stored in a buffer or to be received in the future, reconfigure the segments into one whole RLC PDU, process the RLC PDU, and then deliver the processed RLC PDU to the NR PDCP layer device 4-05 or 4-40.

According to an embodiment of the disclosure, the NR RLC layer device 4-10 or 4-35 may include no concatenation function, which may be performed in the NR MAC layer device 4-15 or 4-30 or replaced with a multiplexing function of the NR MAC layer device 4-15 or 4-30.

Among the above-described functions, the in-sequence delivery of the NR RLC layer device 4-10 or 4-35 may refer to a function of delivering RLC SDUs, received from the lower layer, to the upper layer in sequence.

According to an embodiment of the disclosure, the out-sequence delivery of the NR RLC layer device 4-10 or 4-35 may include a function of, if one original RLC SDU is segmented into multiple RLC SDUs and the segmented RLC SDUs are received, reassembling the multiple received segmented RLC SDUs and delivering the reassembled RLC SDUs to the upper layer.

According to an embodiment of the disclosure, the out-of-sequence delivery function of the NR RLC layer device 4-10 or 4-35 may include a function of storing an RLC sequence number (SN) or a PDCP sequence number (SN) of received RLC PDUs and arranging the sequence to record lost RLC PDUs.

According to an embodiment of the disclosure, the NR MAC layer device 4-15 or 4-30 may be connected to multiple NR RLC layer devices (e.g., the NR RLC layer devices 4-10 and 4-35 in FIG. 4) configured in a single UE, and the main functions of the NR MAC layer device 4-15 or 4-30 may include some of the following functions, but the functions of the NR MAC layer device 4-15 or 4-30 are not limited to the examples given below.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

According to an embodiment of the disclosure, the NR PHY layer device 4-20 or 4-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

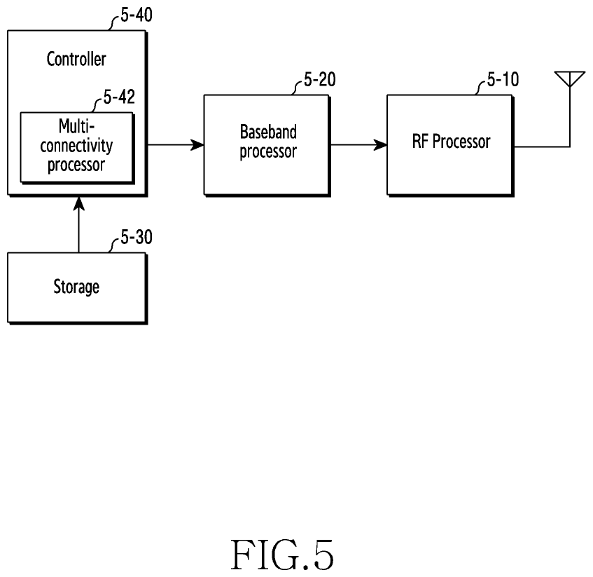

FIG. 5 illustrates a structure of a UE according to an embodiment of the disclosure.

Referring to FIG. 5, the UE according to an embodiment of the disclosure may include a radio frequency (RF) processor 5-10, a baseband processor 5-20, a storage 5-30, and a controller 5-40.

According to an embodiment of the disclosure, the RF processor 5-10 may perform functions for transmitting/receiving signals through a radio channel, such as signal band conversion and amplification. That is, the RF processor 5-10 may up-convert a baseband signal provided from the baseband processor 5-20 to an RF band signal, may transmit the same through an antenna, and may down-convert an RF band signal received through the antenna to a baseband signal. For example, the RF processor 5-10 may include a transmission filter, a reception filter, an amplifier, a mixer, an oscillator, a digital-to-analog converter (DAC), an analog-to-digital converter (ADC), and the like. Although only one antenna is illustrated in FIG. 5, the UE may include multiple antennas. In addition, the RF processor 5-10 may include multiple RF chains. Furthermore, the RF processor 5-10 may perform beamforming. For the beamforming, the RF processor 5-10 may adjust the phase and magnitude of each of signals transmitted and received through multiple antennas or antenna elements. Furthermore, the RF processor 6-10 may perform MIMO. When performing the MIMO operation, the RF processor 5-10 may receive multiple layers. The RF processor 5-10 may appropriately configure multiple antennas or antenna elements to perform reception beam sweeping or may adjust the direction and beam width of a reception beam so as to resonate the reception beam with a transmission beam under the control of the controller.

According to an embodiment of the disclosure, the baseband processor 5-20 may perform functions of conversion between baseband signals and bitstrings according to the system's physical layer specifications. For example, during data transmission, the baseband processing unit 5-20 may encode and modulate a transmitted bitstring to generate complex symbols. In addition, during data reception, the baseband processor 5-20 may demodulate and decode a baseband signal provided from the RF processor 5-10 to restore a received bitstring. For example, when following the orthogonal frequency division multiplexing (OFDM) scheme, during data transmission, the baseband processor 5-20 may encode and modulate a transmitted bitstring to generate complex symbols, may map the complex symbols to subcarriers, and may configure OFDM symbols through inverse fast Fourier transform (IFFT) operation and cyclic prefix (CP) insertion. In addition, during data reception, the baseband processor 5-20 may split a baseband signal provided from the RF processor 5-10 at the OFDM symbol level, may restore signals mapped to subcarriers through a fast Fourier transform (FFT) operation, and may restore a received bitstring through demodulation and decoding.

According to an embodiment of the disclosure, the baseband processor 5-20 and the RF processor 5-10 may transmit and/or receive a signal as described above. In the disclosure, therefore, the baseband processor 5-20 and the RF processor 5-10 may be referred to as a transmitter, a receiver, a transceiver, or a communication unit. Furthermore, at least one of the baseband processor 5-20 and the RF processor 5-10 may include multiple communication modules to support multiple different radio access technologies. In addition, at least one of the baseband processor 5-20 and the RF processor 5-10 may include different communication modules to process signals in different frequency bands. For example, the different radio access technologies may include a wireless LAN (e.g., IEEE 802.11), a cellular network (e.g., LTE), and the like. In addition, the different frequency bands may include super high frequency (SHF) (e.g., 2 NRHz) bands and millimeter wave (mmWave) (e.g., 60 GHz) bands.

According to an embodiment of the disclosure, the storage 5-30 may store basic programs, application programs, and data, such as configuration information, for operation of the main base station. Particularly, the storage 5-30 may store information regarding a second access node configured to perform wireless communication by using a second radio access technology. In addition, the storage 5-30 may provide the stored data at the request of the controller 5-40.

According to an embodiment of the disclosure, the controller 5-40 may control the overall operation of the UE. For example, the controller 5-40 may transmit/receive signals through the baseband processor 5-20 and the RF processor 5-10. In addition, the controller 5-40 may record data in the storage 5-30 and read the data recorded in the storage 5-30. According to an embodiment of the disclosure, the controller 5-40 may include at least one processor. For example, the controller 5-40 includes multi-connectivity processor 5-42. For example, the controller 5-40 may include a communication processor (CP) which performs control for communication and an application processor (AP) which controls upper layers (e.g., application programs).

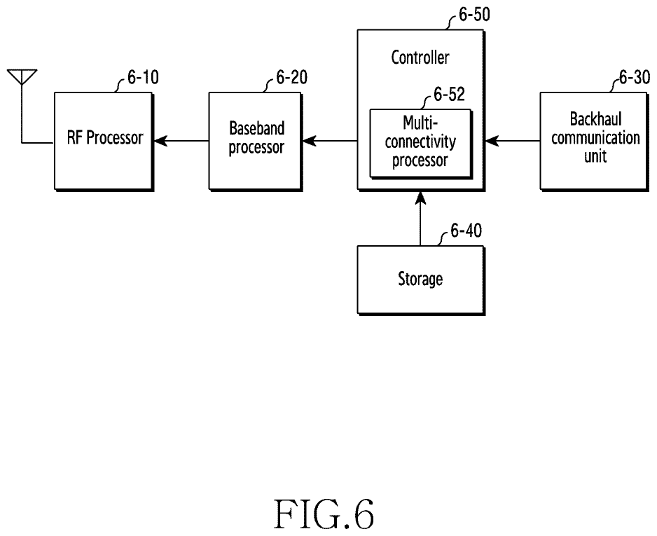

FIG. 6 is a block diagram illustrating a structure of an NR base station according to an embodiment of the disclosure.

FIG. 6 illustrates a structure of a base station according to an embodiment of the disclosure.

Referring to FIG. 6, according to an embodiment of the disclosure, the base station may include an RF processor 6-10, a baseband processor 6-20, a backhaul communication unit 6-30, a storage 6-40, and a controller 6-50, but the structure of the NR base station is not limited to the structure illustrated in FIG. 6. For example, the NR base station may include a smaller or larger number of components than the components illustrated in FIG. 6.

According to an embodiment, the RF processor 6-10 may perform functions for transmitting/receiving signals through a radio channel, such as signal band conversion and amplification. The RF processor 6-10 may up-convert a baseband signal provided from the baseband processor 6-20 to an RF band signal, may transmit the same through an antenna, and may down-convert an RF band signal received through the antenna to a baseband signal. For example, the RF processor 6-10 may include a transmission filter, a reception filter, an amplifier, a mixer, an oscillator, a DAC, and an ADC. Although only one antenna is illustrated in FIG. 6, the RF processing unit 6-10 may include multiple antennas. In addition, the RF processor 6-10 may include multiple RF chains. According to an embodiment of the disclosure, the RF processor 6-10 may perform beamforming. For the beamforming, the RF processor 6-10 may adjust the phase and magnitude of each of signals transmitted and received through multiple antennas or antenna elements. The RF processor may transmit one or more layers to perform a downward MIMO operation.

According to an embodiment, the baseband processor 6-20 may perform a function of conversion between a baseband signal and a bitstream according to a physical layer specification of a first wireless access technology. For example, during data transmission, the baseband processor 6-20 may encode and modulate a transmitted bitstring to generate complex symbols. In addition, during data reception, the baseband processing unit 6-20 may demodulate and decode a baseband signal provided from the RF processing unit 6-10 to restore a received bitstring. For example, when following the OFDM scheme, during data transmission, the baseband processor 6-20 may encode and modulate a transmitted bitstring to generate complex symbols, may map the complex symbols to subcarriers, and may configure OFDM symbols through an IFFT operation and CP insertion. In addition, on receiving data, the baseband processor 6-20 may divide the baseband signal provided from the RF processor 6-10 into units of OFDM symbols, restore signals mapped to subcarriers via the FFT operation, and then restore a received bit stream via demodulation and decoding. The baseband processor 6-20 and the RF processor 6-10 may transmit and receive signals as described above. In the disclosure, therefore, the baseband processor 6-20 and the RF processor 6-10 may be referred to as a transmitter, a receiver, a transceiver, a communication unit, or a wireless communication unit.

According to an embodiment of the disclosure, the backhaul communication unit 6-30 may provide an interface for communicating with other nodes in the network. For example, the backhaul communication unit 6-30 may convert bitstrings transmitted from the main base station to other nodes, for example, an auxiliary base station or a core network, to physical signals, and may convert physical signals received from the other nodes to bitstrings.

According to an embodiment of the disclosure, the storage 6-40 may store basic programs, application programs, and data, such as configuration information, for the operation of the main base station. In particular, the storage 6-40 may store information on bearers allocated to the connected UE, measurement results reported from the connected UE, and the like. In addition, the storage 6-40 may store information serving as a reference to determine whether to provide multi-connection to a UE or to suspend the same. In addition, the storage 6-40 may provide the stored data at the request of the controller 6-50.

According to an embodiment of the disclosure, the controller 6-50 may control the overall operation of the base station. For example, the controller 6-50 may transmit/receive signals through the baseband processor 6-20 and the RF processor 6-10 or through the backhaul communication unit 6-30. In addition, the controller 6-50 may record data in the storage 6-40 and read the data stored in the storage 6-40. To this end, the controller 6-50 may include at least one processor. For example, the controller 6-50 includes multi-connectivity processor 6-52.

According to an embodiment of the disclosure, at least one component in the base station may be implemented as a single chip. In addition, the respective components of the base station may be operated to perform the above-described embodiments of the disclosure.

According to an embodiment of the disclosure, in the case of conditional layer ½ triggered mobility (LTM) or CLTM, a distribution unit (DU) responsible for each cell may determine a condition required for mobility. In addition, a condition required for mobility of CLTM may include a beam-based condition. For example, the beam-based condition may include a beam-based condition, such as A3 or A5.

According to an embodiment of the disclosure, beam information associated with CLTM may include events as follows.
Event LTM3: Beam of candidate cell becomes amount of offset better than beam of serving cell;
Event LTM5: Beam of serving cell becomes worse than absolute threshold1 AND Beam of candidate cell becomes better than another absolute threshold2.

According to an embodiment, while the events included in the beam information are beam-based conditions, a target cell configuration and other CLTM configurations given to a UE may be given on a candidate cell basis. Therefore, inconsistency may occur between configuration units. In addition, when a signal structure is designed based on an event, an update operation of CLTM configuration information occurring in the UE may vary when an additional CLTM operation is assumed.

In the disclosure, a method of associating condition information for CLTM with a specific target cell and indicating the same to the UE may be provided. In addition, since a condition for CLTM is not one-time and may be required in a subsequent operation, the disclosure may provide a method of using a condition for a subsequent operation. Furthermore, the disclosure may provide a method of, when a UE changes a target cell, updating condition information for performing subsequent CLTM by configuring the changed target cell as a source cell.

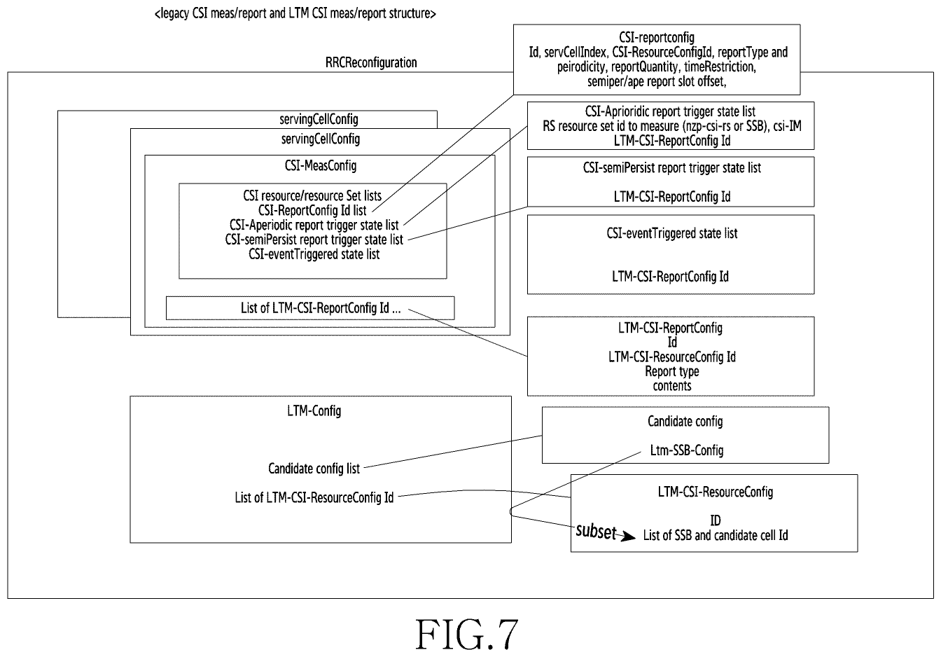

FIG. 7 illustrates legacy L1 CSI measurement and report configuration information for an LTM operation according to an embodiment of the disclosure.

According to an embodiment, a UE may receive an RRCReconfiguration message from a base station. When the UE receives the RRCReconfiguration message, the UE may receive an LTM configuration (LTM-Config) field and a serving cell configuration (servingCellConfig) field. The LTM configuration field and the serving cell configuration field may include information directly used for an LTM operation.

In the disclosure, LTM may refer to an operation in which a network indicates a target beam of a target cell to the UE via L1 measurement and reporting. According to an embodiment, LTM-CSI-ResourceConfig may exist as a measurement target for L1 measurement, and LTM-CSI-ResourceConfig may associate a specific candidate cell ID with a CSI-RS (set) ID or an SSB index to be measured in the cell, thereby indicating a measurement RS in each cell among multiple candidate cells. This information may be indicated as common information in the LTM-Config field regardless of the candidate cell.

According to an embodiment, in the serving cell configuration (servingCellConfig), a list of LTM-CSI-ReportConfig may indicate configuration information for measurement and reporting for LTM. For example, the servingCellConfig field may include the list of LTM-CSI-ReportConfig. In particular, in the list including LTM-CSI-ReportConfig values, one LTM-CSI-ReportConfig may have an ID, and indicate, as a measurement target corresponding to the ID, a specific ID among LTM-CSI-ResourceConfig values existing in the LTM-Config field. In addition, one LTM-CSI-ReportConfig may include report configuration information for the measurement target. For example, for the report configuration information for the measurement target, report periodicity information may be configured as a report type or in a form corresponding to the report type, but a type of the report configuration information is not limited to the periodicity information.

According to an embodiment, the UE may measure an indicated specific CSI target and report the same in a specific report type, based on the serving cell configuration and LTM-Config. The network may indicate one of specific candidate cells to the UE. For example, the network may indicate, to the UE, an ID indicated in LTM-Config. The UE may use, as a target cell, a candidate cell corresponding to the indicated ID, and apply a target cell configuration transferred together for each ID in LTM-Config, thereby performing LTM.

In the disclosure, descriptions are provided by assuming that CLTM may use the same L1 measurement operation as described above. For example, in an embodiment, for CLTM, a specific LTM-CSI-Resource id may be included within LTM-CSI-ReportConfig in the serving cell config field. Accordingly, the measurement target may be indicated to the UE. For example, LTM-CSI-Resource may be included in LTM-Config or CLTM-Config, and indicated to the UE.

In an embodiment, a method of indicating condition information may include a method of associating one or multiple pieces of event information per LTM-CSI-Resource id within LTM-CSI-ReportConfig, or a method of indication and association for each candidate cell in LTM-config or CLTM-config including each candidate cell-specific configuration. According to each method, a different subsequent operation corresponding to each method may be required for the UE.

Hereinafter, the respective methods described above and subsequent operations required for the UE according to the respective methods will be described in detail.

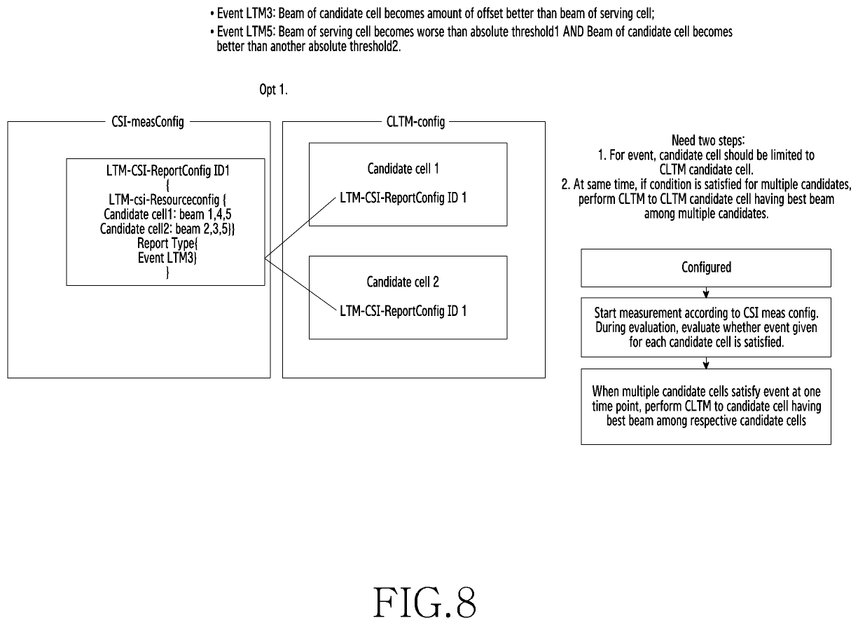

FIG. 8 illustrates configuration information associated with CLTM in Opt 1 and an operation of a UE according to an embodiment of the disclosure.

According to an embodiment, in Opt 1, a base station may indicate, to a UE, condition information associated with an LTM-CSI-ResourceConfig ID by including the condition information in LTM-CSI-ReportConfig within a serving cell configuration. The condition information may include parameters, such as an event type (e.g., LTM3 or LTM5), time-to-trigger, cell-specific offset, evaluation-related hysteresis, and frequency-specific offset, but is not limited thereto. In parallel, the base station may indicate, to the UE, which CSI reportConfig is used for a condition for each candidate cell. For example, CLTM-config may include an indicator (LTM-CSI-ReportConfig ID) indicating which CSI reportConfig is used for a condition for each candidate cell.

According to an embodiment, the UE may receive, via RRCReconfiguration, another configuration for Opt 1. The UE having received the configuration via RRCReconfiguration may measure a resource indicated in CSI-measConfig. For example, the UE may measure a resource of LTM-CSI-resourceConfig. The UE may perform evaluation for the candidate cell-specific condition indicated in CLTM-config. For example, for the event included in LTM-CSI-reportConfig indicated for the candidate cell-specific condition, the UE may perform condition evaluation only for a corresponding candidate cell. That is, event LTM3 is “beam of candidate cell becomes amount of offset better than beam of serving cell” and is defined for an anonymous candidate cell, but only candidate cell 1 indicated with reportConfig may be considered as the candidate cell. In this case, each of candidate cells 1 and 2 may simultaneously satisfy the condition. For example, if a signal strength of a serving cell beam suddenly drops in event LTM3, a difference between the signal strength of the serving cell and signal strengths of beams of multiple candidate cells may exceed an offset threshold value. For example, for event LTM5, in a situation where the beams of the multiple candidate cells exceed an offset threshold value, if the signal of the serving cell beam decreases, the multiple candidate cells may simultaneously satisfy the condition. If the conditions for the multiple candidate cells (e.g., candidate cells 1 and 2) are simultaneously satisfied, the UE may select a target cell based on implementation, or may select, as the target cell, a cell having the best beam among the multiple candidate cells satisfying the conditions. In addition, the UE may select, as a target beam, a beam having a strongest signal strength in the selected target cell. The UE may apply a target cell configuration and perform communication with a network by using the target beam.

In an embodiment, the same LTM-CSI-ReportConfig ID may be indicated for condition information for each different candidate cell. For example, referring to FIG. 8, LTM-CSI-ReportConfig ID 1 may be indicated, to the UE, for condition information of the same candidate cell 1 and candidate cell 2.

In an embodiment, multiple different reportConfig IDs may be indicated for condition information for one candidate cell. In this case, it may be regarded that the condition has been satisfied even if only one event is satisfied, or that the condition has been satisfied if both the indicated events are satisfied. If the condition for the candidate cell is satisfied, the UE may perform corresponding CLTM.

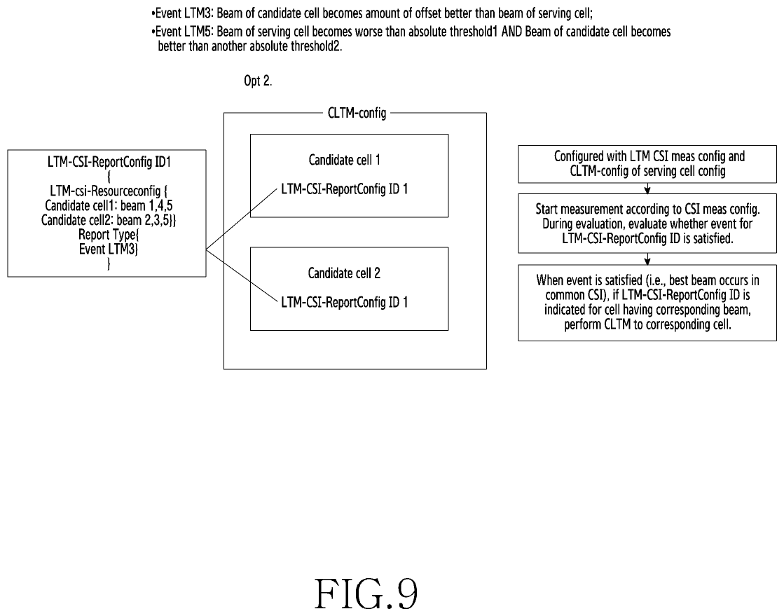

FIG. 9 illustrates configuration information associated with CLTM and an operation of a UE according to an embodiment of the disclosure.

FIG. 9 illustrates configuration information associated with CLTM in Opt 2 and an operation of a UE according to an embodiment of the disclosure.

According to an embodiment, in Opt 2, a base station may indicate, to a UE, condition information associated with an LTM-CSI-ResourceConfig ID by including the condition information in LTM-CSI-ReportConfig within a serving cell configuration. The condition information may include parameters, such as an event type (e.g., LTM3 or LTM5), time-to-trigger, cell-specific offset, evaluation-related hysteresis, and frequency-specific offset, but is not limited thereto. In parallel, the base station may indicate, to the UE, which CSI reportConfig is used for a condition for each candidate cell. For example, CLTM-config may include an indicator (LTM-CSI-ReportConfig ID) indicating which CSI reportConfig is used for a condition for each candidate cell.

A signal transmission and reception scheme in Opt 2 may be understood similarly to that in Opt 1.

According to an embodiment, the UE may receive configuration information for CLTM from the base station. For example, the UE may receive Serving Cell Config from the base station to acquire LTM CSI meas config, and may also acquire CLTM-config that is a separate configuration.

According to an embodiment, for Opt 2, the UE may perform measurement according to an indication of LTM-CSI-ResourceConfig indicated in CSI-measConfig. The UE may perform condition evaluation for the condition information in LTM-CSI-reportConfig. For example, the UE may evaluate whether an event corresponding to the LTM-CSI-ReportConfig ID is satisfied. In this case, candidate cells to be evaluated for event satisfaction may include all candidate cells indicated in CSI-ResourceConfig associated with the reportConfig ID. Information on a candidate cell here may be understood separately from information indicated for each candidate cell in CLTM-config.

According to an embodiment, if a specific candidate cell satisfies an event that is condition information, and a beam of the candidate cell satisfying the condition is discovered, the UE may perform CLTM for the candidate cell based on an additional condition. The additional condition may, for example, refer to a case in which, for the candidate cell having a beam satisfying the event, if the LTM-CSI-ReportConfig ID is included as condition information in LTM-Config and is indicated to the UE, the UE may perform CLTM for the candidate cell.

According to an embodiment, for Opt 2, rather than determining whether a related condition is satisfied for one candidate cell as in Opt 1 (for example, for event LTM3, the condition is satisfied if a beam of one specific candidate cell is better than a beam of a serving cell by offset), if the condition included in LTM-CSI-reportConfig for beams of multiple candidate cells indicated in LTM-CSI-ResourceConfig included in CSI-measConfig is satisfied, the UE immediately moves to the candidate cell (for example, when event LTM3 is considered, if any one of the multiple candidate cells has a beam better than the beam of the serving cell by offset, event LTM3 is satisfied), so that it may be difficult to indicate multiple ReportConfig IDs for multiple conditions for one candidate cell. Accordingly, for Opt 2, a ReportConfig ID of CLTM-config may be understood as information indicating whether a specific cell corresponds to a candidate cell for CLTM.

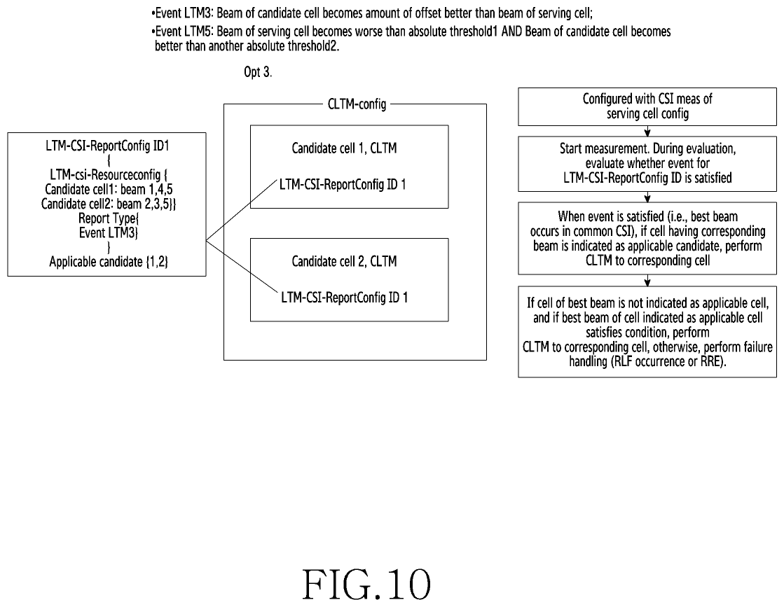

FIG. 10 illustrates configuration information associated with CLTM and an operation of a UE according to an embodiment of the disclosure.

FIG. 10 illustrates configuration information associated with CLTM in Opt 3 and an operation of a UE according to an embodiment of the disclosure.

According to an embodiment, in Opt 3, a candidate cell-specific configuration of CLTM-config may not include separate condition information. Instead, for Opt 3, a base station may indicate, to a UE, a measurement resource indicated by an LTM-CSI-ResourceConfig ID within LTM-CSI-ReportConfig, an event for a condition, and a related parameter. In addition, the base station may additionally indicate an ID of a CLTM candidate cell to which a condition is applied. For example, an ID of an applicable candidate cell (e.g., applicable candidate {1, 2} in FIG. 10) may be included in LTM-CSI-ReportConfig.

According to an embodiment, for Opt 3, an indicator indicating that each candidate cell is a CLTM candidate cell may be included in CLTM-config.

According to an embodiment, the UE may receive the aforementioned configuration information from the base station. For example, the UE may receive a CSI meas configuration of Serving Cell Config. Hereinafter, in an embodiment, descriptions will be provided for operations for, upon reception of the configuration information in Opt 3 described above, performing CLTM based on the received configuration information.

According to an embodiment, the UE having received the configuration may perform measurement and evaluation. For example, the UE may perform measurement on a resource corresponding to LTM-CSI-ResourceConfig in CSI meas config. In addition, the UE may also evaluate whether the indicated event is satisfied. Candidate cells to be evaluated may include all candidate cells indicated by resourceConfig (which may be understood separately from the candidate cells indicated in CLTM-config).

According to an embodiment, if a target beam satisfying the condition and a target cell to which the target beam belongs exist, and the target cell to which the target beam satisfying the condition belongs is included in the CLTM-config configuration, the UE may perform CLTM to the target cell.

According to an embodiment, if multiple condition events are indicated in one LTM-CSI-ResourceConfig, the UE may determine that the condition is satisfied only if all the multiple events are satisfied. Evaluation targets of the event may include candidate cells indicated by resourceConfig and specific beams of the indicated candidate cells (i.e., common CSI).

According to an embodiment, if applicable CLTM candidate information is included in LTM-CSI-ReportConfig, the UE may perform CLTM to a cell that is indicated as an applicable cell among the candidate cells satisfying the condition, and that has the best beam among the cells included in CLTM-config. In other cases, the UE may perform a subsequent operation (failure handling) based on a CLTM failure (e.g., RRC connection re-establishment (RRE) due to occurrence of a radio link failure (RLF)).

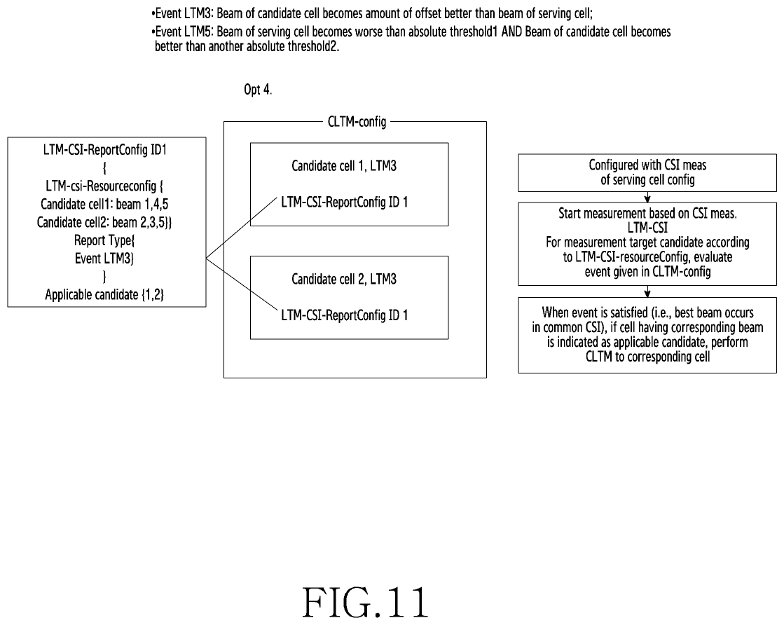

FIG. 11 illustrates configuration information associated with CLTM and an operation of a UE according to an embodiment of the disclosure.

FIG. 11 illustrates configuration information associated with CLTM in Opt 4 and an operation of a UE according to an embodiment of the disclosure.

According to an embodiment, in Opt 4, only a measurement resource indicated by an LTM-CSI-ResourceConfig ID may be indicated in LTM-CSI-ReportConfig. In addition, for each candidate cell, an event applied to a corresponding candidate cell and related parameter information may be indicated in CLTM-config.

According to an embodiment, the UE may receive the aforementioned configuration information from the base station. For example, the UE may receive CSI meas configuration information of serving cell config.

In an embodiment, the UE may perform measurement and evaluation based on the configuration information received from the base station. For example, the UE may perform measurement on candidate beams of a candidate cell indicated in report config of CSI meas. The UE may evaluate, for each CLTM candidate, whether an event indicated to the UE itself is satisfied. The measurement and evaluation of the UE in Opt 4 may be understood similarly to those in Opt 1. That is, the candidate cell to be evaluated for the event may be understood to be limited to a candidate cell for which the event is indicated. The candidate cells indicated in reportConfig may be suitable for use when only one specific event is indicated. That is, even if measurement on one candidate cell is performed by the UE in association with multi-resource configuration (resource config) information, it may be difficult to express information related to an event with which measurement in a specific reportConfig ID is associated.

According to an embodiment, if a cell having the best beam among candidate cells having beams satisfying the event is indicated as an applicable candidate in LTM-CSI-ReportConfig, the UE may perform CLTM using the candidate cell as a target cell.

The methods according to Opts 1 to 4 described above may indicate a scheme of associating specific condition information with a candidate cell.

In an embodiment, after being configured by the base station, even if the UE has performed CLTM once by initial mobility, the UE should subsequently be able to automatically perform condition measurement and evaluation for performing CLTM to another cell by considering the target cell as a source cell.

Accordingly, initial configuration conditions and condition information for subsequent CLTM may need to be included in an RRCReconfiguration message. For example, at least the following information may be included in LTM or CLTM configuration (CLTM-config) and transferred to the UE for each candidate cell.
LTM or CLTM candidate cell ID
PCI for the LTM or CLTM candidate cell
Target cell configuration of LTM or CLTM candidate cell
Initial and subsequent condition information

In an embodiment, according to condition expression methods, for Opt 1 and Opt 2, initial condition information and subsequent condition information for one candidate cell may be required in CLTM-config.

According to an embodiment, initial conditions may include an LTM-CSI-ReportConfig ID. There may be multiple LTM-CSI-ReportConfig IDs. In this case, multiple conditions included in the initial conditions may be determined based on an AND logical combination. For example, the UE may determine that the initial conditions are satisfied when all the multiple conditions included in the initial conditions are satisfied. In addition, the LTM-CSI-ReportConfig ID may need to be included in LTM-CSI-ReportConfig within CSI-measConfig of a serving cell configuration. Information that needs to be included in LTM-CSI-ReportConfig may correspond to a condition required to be considered when the UE moves from a current cell to a target cell associated with this condition.

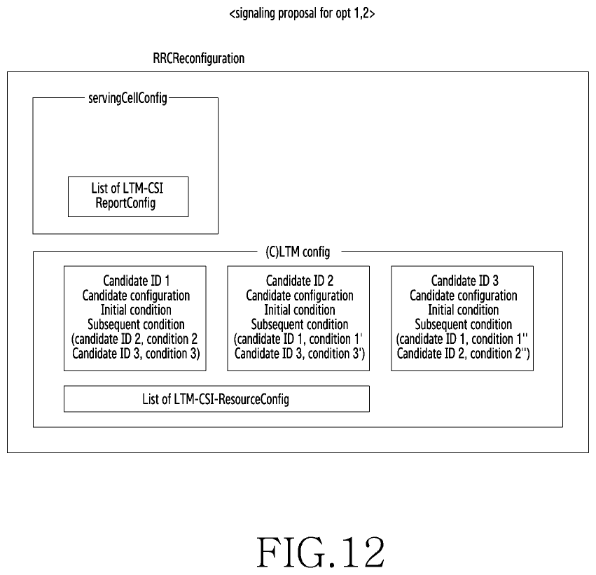

In the disclosure, a subsequent condition may refer to condition information required to be considered when the UE moves to a candidate cell and then moves from the candidate cell to “another candidate cell”. For example, in Opts 1 and 2, referring to FIG. 12, a subsequent condition may refer to condition information required to be considered when the UE, after having moved to a candidate cell corresponding to candidate ID 1, moves to other candidate cells corresponding to candidate IDs 2 and 3. According to an embodiment, a subsequent condition may include an indicator (e.g., a CLTM ID or PCI) indicating “another candidate cell,” and condition information to be considered. For example, the condition information to be considered may include association information of an LTM-CSI-ReportConfig ID.

In an embodiment, the LTM-CSI-ReportConfig ID and configuration information may need to be configured in CSI-measConfig of the serving cell configuration of the cell (serving cell before moving to another candidate cell).

According to an embodiment, for Opt 4, event information corresponding to initial CLTM required to be considered when moving to a specific candidate cell, and condition information required to be considered when the UE moves to another candidate cell after moving to the specific candidate cell according to the initial CLTM may be indicated together in CLTM-config. The condition information required to be considered when the UE moves to another candidate cell may include event information.

According to an embodiment, for Opt 3, separate condition information may not be required. Instead, an indicator (CLTM indicator) or indication (CLTM indication) indicating that the specific candidate cell is a CLTM candidate cell may be included.

FIG. 12 illustrates a configuration of condition-associated information included in an RRCReconfiguration message transferred to a UE in cases of Opts 1 and 2 according to an embodiment of the disclosure. For Opts 1 and 2, CLTM-config may include, in LTM-CSI-ResourceConfig, a list of candidate cells required for measurement and beam information in the candidate cells. In addition, for Opts 1 and 2, a specific ID may be configured to be included, in LTM-CSI-ReportConfig, as measurement and evaluation information for CLTM in a current serving cell.

According to an embodiment, for Opts 1 and 2, CLTM-config may include, for each candidate cell, a candidate cell configuration as well as initial and subsequent conditions. For example, referring to FIG. 12, CLTM-config may include, for each of candidate cells corresponding to candidate IDs 1 to 3, a candidate configuration, an initial condition, and a subsequent condition. The subsequent condition may include condition information required when a UE moves to a corresponding associated cell and then moves to another candidate cell. The condition information required when moving to another candidate cell may be indicated in association with information of the other candidate cell. For example, referring to FIG. 12, condition 2 may be indicated in association with candidate ID 2. For example, condition 3 may be indicated in association with candidate ID 3.

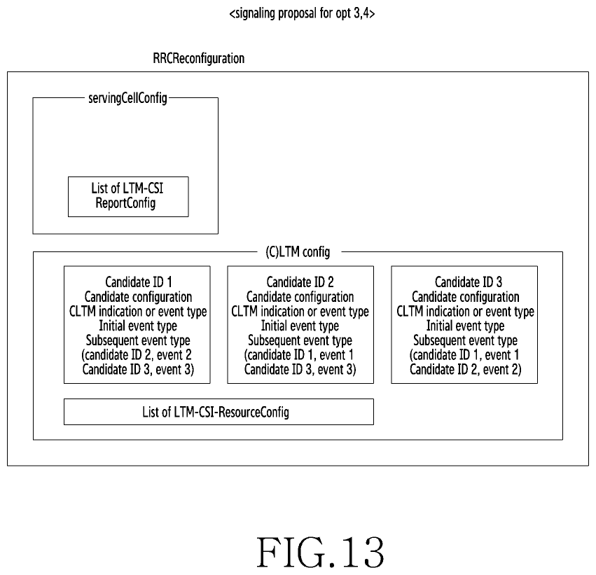

FIG. 13 illustrates a configuration of condition-associated information included in an RRCReconfiguration message transferred to a UE in cases of Opts 3 and 4 according to an embodiment of the disclosure. For Opts 3 and 4, CLTM-config may include, in LTM-CSI-ResourceConfig, a list of candidate cells required for measurement and beam information in the candidate cells. In addition, for Opts 3 and 4, a specific ID may be configured to be included, in LTM-CSI-ReportConfig, as measurement and evaluation information for CLTM in a current serving cell.

According to an embodiment, for Opts 3 and 4, CLTM-Config may include, for each candidate cell, a candidate cell configuration and either an indicator indicating that a candidate cell is a CLTM candidate cell or condition information. For example, the condition information may refer to event information associated with an initial condition and a subsequent condition. For example, referring to FIG. 13, for Opts 3 and 4, CLTM-config may include, for each of candidate cells corresponding to candidate IDs 1 to 3, an initial event type or a subsequent event type. The subsequent condition may include condition information required when a UE moves to a corresponding associated cell and then moves to another candidate cell. In an embodiment, the condition information required when moving to another candidate cell may be indicated in association with information of the other candidate cell. For example, referring to FIG. 13, for Opts 3 and 4, a candidate cell corresponding to candidate ID 1 may be associated with candidate IDs 2 and 3 and events 2 and 3, respectively, and indicated, wherein events 2 and 3 are events of candidate cells corresponding to candidate IDs 2 and 3, respectively.

In the disclosure, the terms “event type”, “event information”, or “condition information” may refer to not only event type information but also all other parameters required to determine a corresponding condition.

According to an embodiment, a UE having received configuration information from a base station may include and store the received configuration information in CLTM-config IE or a CLTM variable, or may include the configuration information in LTM-config and store the same in memory. When the UE includes the received configuration information in LTM-config and stores the same in the memory, the UE may determine, based on condition information or a CLTM indicator, whether each candidate cell is a CLTM candidate cell.

According to an embodiment, the UE may perform measurement via an LTM-CSI-measConfig configuration. In addition, the UE may perform condition evaluation based on the condition information. In this case, the UE may perform evaluation according to an initial condition. If a specific candidate cell satisfies the condition, the UE may perform LTM by selecting the candidate cell as a target cell.

According to an embodiment, the UE may perform LTM to the specific candidate cell satisfying the condition and apply a configuration of the cell.

According to an embodiment, for Opts 1 and 2, the UE may update the condition information based on a changed serving cell. The updating of the condition information by the UE may include, for the changed serving cell, updating existing initial condition information of candidate cells in CLTM-config to conditions for respective “other candidate cells”, based on subsequent condition information received before performing LTM.

According to an embodiment, the updating of the condition information by the UE may include, when an “other candidate cell” ID exists as a candidate cell in current CLTM-config, changing the initial condition to subsequent condition information associated with the “other candidate cell”.

According to an embodiment, the updating of the condition information by the UE may include, when the “other candidate cell” ID does not exist as a candidate cell in CLTM-config or is deactivated, adding or updating the initial condition as subsequent condition information associated with the “other candidate cell”.

According to an embodiment, the updating of the condition information by the UE may include, when a candidate cell that does not correspond to the “other candidate cell” ID exists as a candidate cell in current CLTM-config, removing or deactivating the initial condition of the candidate cell.

According to an embodiment, the UE may perform measurement for an LTM-CSI-Resource associated with LTM-CSI-ReportConfig indicated in a new serving cell configuration, and may perform condition evaluation based on the updated initial condition information.

According to an embodiment, for Opt 4, updating condition information by the UE may include the aforementioned updating of the condition information. In the updating of the condition information by the UE, an updating target may refer to a condition of each candidate cell. For example, while a reportConfig id may be considered in Opts 1 and 2, the same updating procedure may be performed in Opt 4 by considering an event type.

In an embodiment of the disclosure, for Opt 3, separate condition information may not exist in CLTM-config. Instead, for Opt 3, serving cell config may include both a measurement target and condition information. Accordingly, the UE may perform measurement and condition evaluation based on the included information.

According to an embodiment, a signal between a central unit (CU) and a distribution unit (DU) based on F1 may be required for the UE to obtain a network configuration. F1 is an F1 interface and may refer to an interface between a CU and a DU. Hereinafter, a signal between a CU and a DU will be described.

In an embodiment, transferring a signal from a CU to a candidate DU, the transferring of the signal from the CU to the candidate DU may include transferring a request message for CLTM resource reservation. The same message as a resource request message in existing LTM may be used for the request message. The request message may include a specific UE ID and an indicator indicating that the message is a request for CLTM. In addition, the request message may include configuration information of a current source cell. In addition, the request message may include a candidate spCell ID proposed by the CU.

According to an embodiment, transferring a signal from the candidate DU to the CU, the candidate DU having received the request message may determine a candidate cell admitted by the DU among proposed candidate cells, and may generate target cell configuration information in the determined candidate cell. In addition, for a subsequent condition, the DU may determine condition information for movement from the determined candidate cell to other candidate cells (e.g., cells not allocated to the DU among the candidate cells proposed by the CU). The condition information may include an event type and parameters for a target candidate cell. Alternatively, the condition information may include a specific event type for an anonymous candidate cell. The DU may determine a beam (i.e., a CSI resource or a beam index) to be measured in each admitted cell. The DU may transfer information on the determined beam to the CU.

According to an embodiment, for a signal transferred from the CU to a serving DU, the CU having received the information on the determined beam from the candidate DU may transfer the received information to the serving DU.

According to an embodiment, in the transferring of the signal from the serving DU to the CU, the serving DU may receive CSI resource information for each candidate cell. In addition, based on admitted candidate cell information, condition information required to be considered when moving from the current serving cell to another admitted candidate cell may be determined. The serving DU may determine an initial condition and a subsequent condition for each admitted candidate cell. (Alternatively, the condition information may be determined after receiving information on all candidate cells admitted from other CUs to be described below.) In addition, the serving DU may generate LTM-CSI-ResourceConfig considered in the current serving cell, based on CSI information received from all candidate CUs. In addition, the serving DU may generate LTM-CSI-ReportConfig referring to a corresponding resource, and may include the generated LTM-CSI-ReportConfig in serving cell configuration. The serving DU may transfer the determined condition information to the CU. The serving DU may transfer the generated CSI-ResourceConfig to the CU.

According to an embodiment, in transferring a signal from the CU to the candidate DU, the transferring of the signal from the CU to the candidate DU may include transferring all the information mentioned in the operations above to the candidate DU. For example, the CU may transfer, to all candidate DUs, condition information determined by the serving DU, subsequent condition information determined by another candidate DU, and CSI resource information.

According to an embodiment, in the transferring of the signal from the candidate DU to the CU, the transferring of the signal from the candidate DU to the CU may include generating LTM-CSI-ReportConfig within the serving cell configuration by the candidate DU in consideration of a candidate cell admitted by another candidate DU and a CSI resource of the candidate cell, the LTM-CSI-ReportConfig being generated as a subsequent condition determined by the candidate DU. The transferring of the signal from the candidate DU to the CU may include generating, in the candidate cell of the candidate DU, LTM-CSI-ResourceConfig information in consideration of CSI of another DU or another candidate cell of the current DU, and a report configuration associated with the generated LTM-CSI-ResourceConfig information, so as to add the generated LTM-CSI-ResourceConfig information and report configuration to a serving cell configuration of each admitted cell.

According to an embodiment, in the transferring of the signal from the CU to the UE, the transferring of the signal from the CU to the UE may include transferring, to the UE by the CU, the condition information and cell configuration for each candidate cell determined in the previous operation. The condition information and cell configuration for each candidate cell determined in the previous operation may include a serving cell configuration and LTM-CSI-ReportConfig within the configuration. In an embodiment, for Opts 1 and 2, CLTM-config may include a candidate cell-specific report configuration indicator (report config ID) as a condition.

Methods disclosed in the claims or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including random access memory and flash memory, read only memory (ROM), electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, from a base station (BS), configuration information for a layer ½ triggered mobility (LTM), and condition information for a conditional LTM (CLTM);
identifying a candidate cell for the CLTM based on the condition information;
identifying a candidate beam of the identified candidate cell based on the condition information;
performing a condition evaluation for the candidate beam of the candidate cell based on a layer 1 (L1) measurement for the candidate beam; and
performing a CLTM procedure for the candidate cell based on an corresponding LTM candidate configuration included in the configuration information, in case that a condition in the condition information is fulfilled for the candidate beam.

2. The method of claim 1,
wherein the condition information includes an indicator for indicating a candidate identifier (ID) of the candidate cell for the CLTM,
wherein the candidate ID is associated with an LTM-channel state information (CSI) report configuration identifier (ID) for indicating the condition.

3. The method of claim 2,
wherein the condition evaluation is performed based on an event associated with the LTM-CSI report configuration ID,
wherein an LTM-CSI report configuration corresponding to the LTM-CSI report configuration ID includes an indicator for indicating a type of the event.

4. The method of claim 3, wherein the type of the event is an LTM3 event or an LTM5 event.

5. The method of claim 3,
wherein the LTM-CSI report configuration further includes a time-to-trigger (TTT) parameter for the event,
wherein the condition is fulfilled in case that the event is fulfilled during the TTT.

6. The method of claim 3,
wherein the LTM-CSI report configuration further includes a hysteresis parameter for the event.

7. The method of claim 3,
wherein the condition information is associated with an LTM-CSI resource configuration ID associated with the LTM-CSI report configuration,
wherein the candidate beam is identified based on the LTM-CSI resource configuration ID.

8. The method of claim 7,
wherein an LTM-CSI resource configuration corresponding to the LTM-CSI resource configuration ID includes a channel state information-reference signal (CSI-RS) resource ID or a synchronization signal block (SSB) index for indicating a resource for the L1 measurement.

9. A method performed by a base station (BS) in a wireless communication system, the method comprising:
transmitting, to a user equipment (UE), configuration information for a layer ½ triggered mobility (LTM), and condition information for a conditional LTM (CLTM); and
performing a CLTM procedure for a candidate cell based on an corresponding LTM candidate configuration included in the configuration information, in case that a condition in the condition information is fulfilled for a candidate beam of the candidate cell,
wherein an identification of the candidate cell and the candidate beam is based on the condition information,
wherein an evaluation of the condition is based on a layer 1 (L1) measurement for the candidate beam.

10. The method of claim 9,
wherein the condition information includes an indicator for indicating a candidate identifier (ID) of the candidate cell for the CLTM,
wherein the candidate ID is associated with an LTM-channel state information (CSI) report configuration identifier (ID) for indicating the condition.

11. A user equipment (UE) comprising:
at least one transceiver;
at least one processor communicatively coupled to the at least one transceiver; and
at least one memory, communicatively coupled to the at least one processor, storing instructions executable by the at least one processor individually or in any combination to cause the UE to:
receive, from a base station (BS), configuration information for a layer ½ triggered mobility (LTM), and condition information for a conditional LTM (CLTM),
identify a candidate cell for the CLTM based on the condition information,
identify a candidate beam of the identified candidate cell based on the condition information,
perform a condition evaluation for the candidate beam of the candidate cell based on a layer 1 (L1) measurement for the candidate beam, and
perform a CLTM procedure for the candidate cell based on an corresponding LTM candidate configuration included in the configuration information, in case that a condition in the condition information is fulfilled for the candidate beam.

12. The UE of claim 11,
wherein the condition information includes an indicator for indicating a candidate identifier (ID) of the candidate cell for the CLTM,
wherein the candidate ID is associated with an LTM-channel state information (CSI) report configuration identifier (ID) for indicating the condition.

13. The UE of claim 12,
wherein the condition evaluation is performed based on an event associated with the LTM-CSI report configuration ID,
wherein an LTM-CSI report configuration corresponding to the LTM-CSI report configuration ID includes an indicator for indicating a type of the event.

14. The UE of claim 13, wherein the type of the event is an LTM3 event or an LTM5 event.

15. The UE of claim 13,
wherein the LTM-CSI report configuration further includes a time-to-trigger (TTT) parameter for the event,
wherein the condition is fulfilled in case that the event is fulfilled during the TTT.

16. The UE of claim 13,
wherein the LTM-CSI report configuration further includes a hysteresis parameter for the event.

17. The UE of claim 13,
wherein the condition information is associated with an LTM-CSI resource configuration ID associated with the LTM-CSI report configuration,
wherein the candidate beam is identified based on the LTM-CSI resource configuration ID.

18. The UE of claim 17,
wherein an LTM-CSI resource configuration corresponding to the LTM-CSI resource configuration ID includes a channel state information-reference signal (CSI-RS) resource ID or a synchronization signal block (SSB) index for indicating a resource for the L1 measurement.

19. A base station (BS) comprising:
at least one transceiver;
at least one processor communicatively coupled to the at least one transceiver; and
at least one memory, communicatively coupled to the at least one processor, storing instructions executable by the at least one processor individually or in any combination to cause the BS to:
transmit, to a user equipment (UE), configuration information for a layer ½ triggered mobility (LTM), and condition information for a conditional LTM (CLTM), and
perform a CLTM procedure for a candidate cell based on an corresponding LTM candidate configuration included in the configuration information, in case that a condition in the condition information is fulfilled for a candidate beam of the candidate cell,
wherein an identification of the candidate cell and the candidate beam is based on the condition information,
wherein an evaluation of the condition is based on a layer 1 (L1) measurement for the candidate beam.

20. The BS of claim 19,
wherein the condition information includes an indicator for indicating a candidate identifier (ID) of the candidate cell for the CLTM,
wherein the candidate ID is associated with an LTM-channel state information (CSI) report configuration identifier (ID) for indicating the condition.
